(19) United States
(12) Patent Application Publication
(10) Pub. No.: US 2019/0111751 A1
(43) Pub. Date: Apr. 18, 2019

(54) INTERNAL GAS SPRING DISPLACEMENT SENSORS AS WELL AS GAS SPRING ASSEMBLIES AND SUSPENSION SYSTEMS INCLUDING SAME

(71) Applicant: Firestone Industrial Products Company, LLC, Nashville, TN (US)

(72) Inventors: Larry L. Lockridge, Fishers, IN (US); Samuel N. Mbugua, Zionsville, IN (US); Bryce A. Carrico, Fort Wayne, IN (US); Michael E. Hunley, Fort Wayne, IN (US); Erik T. Cowans, Fort Wayne, IN (US)

(21) Appl. No.: 16/089,189

(22) PCT Filed: Mar. 28, 2017
(86) PCT No.: PCT/US17/24623

§ 371 Date: Sep. 27, 2018

Related U.S. Application Data
(60) Provisional application No. 62/460,629, filed on Feb. 17, 2017.
(60) Provisional application No. 62/314,369, filed on Mar. 28, 2016.

(51) Int. Cl. B60G 11/27; F16F 9/05; F16F 9/36; F16F 9/32; G01S 17/08; G01S 7/481

(52) U.S. Cl. CPC B60G 11/27; F16F 9/05; F16F 9/369; F16F 9/3292; G01S 17/08; B60G 17/019; G01S 7/4816; G01S 7/4814; F16F 2222/126; F16F 2230/08; G01S 7/4813

(57) ABSTRACT

Displacement sensors can include a photon source and a target surface disposed in spaced relation to the photon source. Displacement sensors can also include a photon receptor disposed along an associated gas spring end member in spaced relation to the target surface. A processor can be communicatively coupled with the photon source and the photon receptor. The photon source can be operable to direct photons toward the target surface. The photon receptor can be operable to generate a signal upon receiving photons reflected off the target surface from the photon source. The processor can operate to determine a distance having a relationship to a time of flight of photons reflected off of the target surface from the photon source and received at the photon receptor. A gas spring assembly including such a displacement sensor, and a suspension system including one or more of such gas spring assemblies are also included.

### BACKGROUND

The subject matter of the present disclosure broadly relates to the art of spring devices and, more particularly, to internal gas spring displacement sensors operative to generate signals, data and/or other outputs having a relation to heights or distances associated with gas spring assemblies based on time-of-flight measurement of photons. Gas spring assemblies including such constructions as well as suspension systems including one or more of such gas spring assemblies are also included.

It will be appreciated that the subject displacement sensors, as well as the gas spring assemblies and suspension system that include one or more of such displacement sensors, are amenable to broad use in a wide variety of applications and environments. As examples, suitable applications and/or uses can include vehicle suspension systems, cab mounting arrangements and seat suspensions such as may exist over-the-road trucks and tractors, rail vehicles, agricultural vehicles, industrial vehicles, as well as in other machinery having moving or vibrating parts. It will be appreciated that the subject matter of the present disclosure may be particularly amenable to use in connection with motorized vehicles, and will be discussed in detail hereinafter with specific reference thereto. However, it is to be specifically understood that the subject displacement sensors, as well as the gas spring assemblies and suspension systems that include one or more of such displacement sensors, are not intended to be in any way limited to this specific example of one suitable application, which is merely exemplary.

Wheeled motor vehicles of most types and kinds include a sprung mass, such as a body or chassis, for example, and an unsprung mass, such as two or more axles or other wheel-engaging members, for example, with a suspension system disposed therebetween. Typically, such a suspension system will include a plurality of spring devices as well as a plurality of damping devices that together permit the sprung and unsprung masses of the vehicle to move in a somewhat controlled manner relative to one another. Generally, the plurality of spring elements function to accommodate forces and loads associated with the operation and use of the vehicle, and the plurality of damping devices are operative to dissipate undesired inputs and movements of the vehicle, particularly during dynamic operation thereof. Movement of the sprung and unsprung masses toward one another is normally referred to in the art as jounce motion while movement of the sprung and unsprung masses away from one another is commonly referred to in the art as rebound motion.

In some cases, the spring devices of vehicle suspension systems can be of a type and kind that are commonly referred to in the art as gas spring assemblies, which are understood to utilize pressurized gas as the working medium thereof. Typically, such gas spring assemblies include a flexible spring member that is operatively connected between comparatively rigid end members to form a spring chamber. Pressurized gas can be transferred into and/or out of the spring chamber to alter the position of the sprung and unsprung masses relative to one another and/or to provide other performance-related characteristics. Additionally, a variety of devices and/or arrangements have been and are currently used to assist in controlling the transfer of pressurized gas into and/or out of one or more spring chambers and thereby adjust the position and/or orientation of one structural component of a vehicle relative to another structural component. As one example, a mechanical linkage valve that is in fluid communication between a compressed gas source and a gas spring assembly can be interconnected between the opposing structural components. As the structural components move toward and away from one another, the valve opens and closes to permit pressurized gas to be transferred into and out of the gas spring assembly. In this manner, such mechanical linkage valves can permit control of the height of the gas spring assembly.

Unfortunately, such arrangements have a number of problems and/or disadvantages that are commonly associated with the continued use of the same. One problem with the use of mechanical linkage valves, particularly those used in association with the suspension system of a vehicle is that the linkages are frequently subjected to physical impacts, such as may be caused by debris from a roadway, for example. This can result in the linkage being significantly damaged or broken, such that the valve no longer operates properly, if the valve operates at all.

Due to the potential for known mechanical linkage valves to be damaged, regular inspection and replacement of such mechanical linkage valves is typically recommended. Another disadvantage of known mechanical linkage valves relates to the performance and operation thereof in connection with an associated suspension system. That is, known mechanical linkage valves generally open and close under predetermined height conditions regardless of the operating condition or inputs acting on the vehicle. As such, it is possible that operating conditions of the vehicle might occur during which the performance of a height change would be undesirable. Unfortunately, conventional suspension systems that utilize mechanical linkage valves are not typically capable of selective operation.

In view of the foregoing difficulties commonly associated with the use of mechanical linkage valves, height control systems for vehicle suspensions have been developed that utilize non-contact height sensors and thereby avoid the use of mechanical linkage valves. Such non-contact height sensors are commonly housed within a gas spring assembly and can utilize sound or pressure waves traveling through a fluid medium, typically at an ultrasonic frequency, to generate output signals suitable for determining the position of one structural member relative to another structural member. As an example of such an application, an ultrasonic sensor could be supported on one end member of a gas spring assembly. The ultrasonic sensor can be operative to send ultrasonic waves through the spring chamber of the gas spring assembly toward an opposing end member. The waves are reflected back by a suitable feature of the opposing end member, and the distance therebetween is determined in a conventional manner.

One advantage of such an arrangement over mechanical linkages is commonly housed within the gas spring assembly and is at least partially sheltered from impacts and exposure. However, numerous disadvantages also exist with the use of sensors that utilize ultrasonic sound waves that travel toward and are reflected back from a distant target. As one example, sound waves can be subject to interference from external sources, such as those within the gas spring assembly or in the environment around the gas spring assembly, which can degrade or otherwise diminish the performance of the height control system. What's more, environmental factors such as pressure, temperature and relative humidity alter speed with which sound will travel through the gas within the gas spring assembly. These and other factors can disadvantageously affect the accuracy and/or consistency with which height control systems can operate using known ultrasonic sensors.

Notwithstanding the widespread usage and overall success of conventional displacement sensors, as well as the gas spring assemblies and suspension systems including such sensors, that are known in the art, it is believed that a need exists to address the foregoing and/or other challenges while providing comparable or improved performance, ease of manufacture, reduced cost of manufacture, and/or otherwise advancing the art of gas spring devices and displacement sensors therefor.

### BRIEF SUMMARY

One example of a displacement sensor in accordance with the subject matter of the present disclosure can include a photon source and a target surface disposed in spaced relation to the photon source. The displacement sensor can also include a photon receptor disposed along an associated gas spring end member in spaced relation to the target surface. A processor can be communicatively coupled with the photon source and the photon receptor. The photon source can be operable to direct photons toward the target surface. The photon receptor can be operable to generate a signal upon receiving photons reflected off the target surface from the photon source. The processor can be operable to determine a distance having a relationship to a time of flight of photons reflected off of the target surface from the photon source and received at the photon receptor.

A gas spring assembly in accordance with the subject matter of the present disclosure can have a longitudinal axis. The gas spring assembly can include a flexible spring member that can include a flexible wall extending peripherally about the longitudinal axis and axially between opposing first and second ends of the flexible spring member to at least partially define a spring chamber therebetween. A first end member can be secured along the first end of the flexible spring member such that a substantially fluid-tight seal is formed therebetween. A second end member can be disposed in axially-spaced relation to the first end member. The second end member can be secured along the second end of the flexible spring member such that a substantially fluid-tight seal is formed therebetween. A photon source can be operatively disposed along one of the first and second end members. A target surface can be operatively disposed along one of the first and second end members. A photon receptor can be operatively disposed along the other of the first and second end members relative to the target surface. A processor can be communicatively coupled with the photon source and the photon receptor. The photon source can be operable to direct photons toward the target surface through at least a portion of the spring chamber. The photon receptor can be operable to generate a signal upon receiving photons reflected off the target surface from the photon source. The processor can be operable to determine a distance having a relationship to a time of flight of photons reflected off of the target surface from the photon source and received at the photon receptor.

One example of a suspension system in accordance with the subject matter of the present disclosure can include a pressurized gas system that includes a pressurized gas source and a control device. The suspension system can also include at least one gas spring assembly according to the foregoing paragraph. The at least one gas spring assembly can be disposed in fluid communication with the pressurized gas source through the control device such that pressurized gas can be selectively transferred into and out of the spring chamber.

### BRIEF DESCRIPTION OF THE DRAWINGS

FIG. 1 is a schematic representation of one example of a vehicle including a suspension system with a plurality of gas spring assemblies and a plurality of displacement sensors in accordance with the subject matter of the present disclosure.

FIG. 2 is a side elevation view of one example of a gas spring assembly including one example of a displacement sensor in accordance with the subject matter of the present disclosure.

FIG. 3 is a cross-sectional side view of the gas spring assembly and displacement sensor in FIG. 2 taken from along line 3-3 in FIG. 2.

FIG. 4 is a cross-sectional side view of one example of a gas spring and damper assembly including another example of a displacement sensor in accordance with the subject matter of the present disclosure.

FIG. 5 is an enlarged view of the portion of the gas spring and damper assembly and the displacement sensor identified as Detail 5 in FIG. 4.

FIG. 6A is a top perspective view and FIG. 6B is a bottom perspective view of one example of a displacement sensor in accordance with the subject matter of the present disclosure, such as may be suitable for use as the displacement sensor illustrated in FIGS. 4 and 5.

FIG. 7 is a side elevation view of the exemplary displacement sensor shown in FIGS. 6A and 6B.

FIG. 8 is a front view of the exemplary displacement sensor shown in FIGS. 6A, 6B and 7.

FIG. 9 is a bottom plan view of the exemplary displacement sensor shown in FIGS. 6A, 6B, 7 and 8.

FIG. 10 is a schematic representation of one example of a displacement sensor in accordance with the subject matter of the present disclosure.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purpose of clarity and ease of understanding.

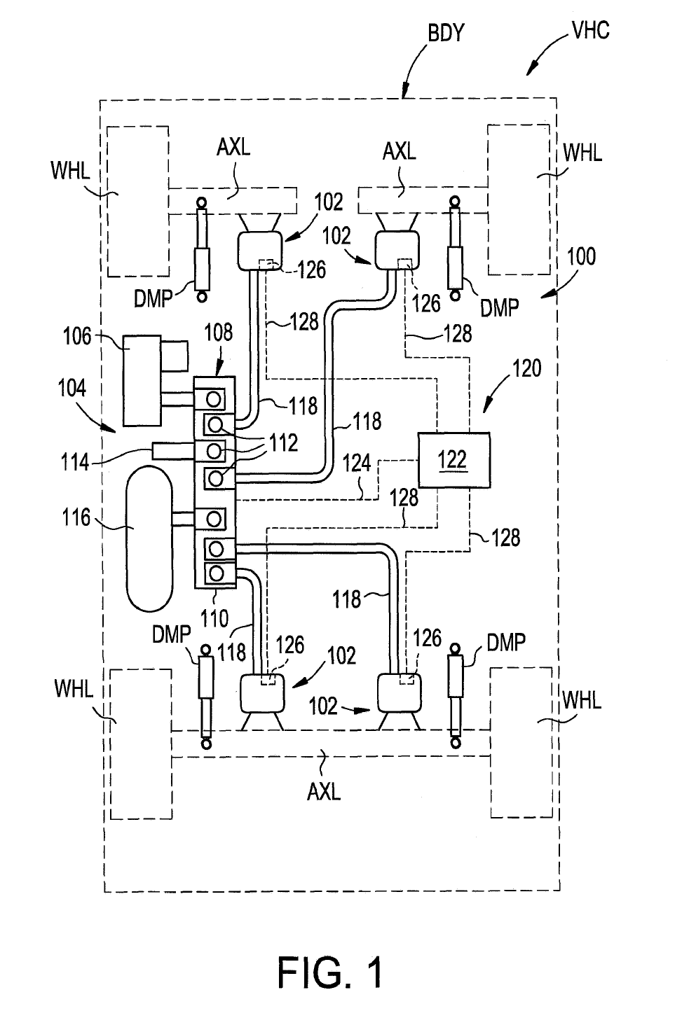

FIG. 1 illustrates one example of a suspension system 100 disposed between a sprung mass, such as an associated vehicle body BDY, for example, and an unsprung mass, such as an associated wheel WHL or an associated axle AXL, for example, of an associated vehicle VHC. It will be appreciated that any one or more of the components of the suspension system can be operatively connected between the sprung and unsprung masses of the associated vehicle in any suitable manner.

The suspension system can also include a plurality of gas spring assemblies supported between the sprung and unsprung masses of the associated vehicle. In the arrangement shown in FIG. 1, suspension system 100 includes four gas spring assemblies 102, one of which is disposed toward each corner of the associated vehicle adjacent a corresponding wheel WHL. However, it will be appreciated that any other suitable number of gas spring assemblies could alternately be used in any other configuration and/or arrangement. As shown in FIG. 1, gas spring assemblies 102 are supported between axles AXL and body BDY of associated vehicle VHC. Additionally, it will be recognized that the gas spring assemblies shown and described in FIG. 1 (e.g., gas spring assemblies 102) are illustrated as being of a rolling lobe-type construction. It is to be understood, however, that gas spring assemblies of other types, kinds and/or constructions could alternately be used. Depending on desired performance characteristics and/or other factors, the suspension system will typically include damping members, such as dampers DMP, for example, of a typical construction that are provided separately from gas spring assemblies 102 and secured between the sprung and unsprung masses in a conventional manner.

Suspension system 100 also includes a pressurized gas system 104 operatively associated with the gas spring assemblies for selectively supplying pressurized gas (e.g., air) thereto and selectively transferring pressurized gas therefrom. In the exemplary embodiment shown in FIG. 1, pressurized gas system 104 includes a pressurized gas source, such as a compressor 106, for example, for generating pressurized air or other gases. A control device, such as a valve assembly 108, for example, is shown as being in communication with compressor 106 and can be of any suitable configuration or arrangement. In the exemplary embodiment shown, valve assembly 108 includes a valve block 110 with a plurality of valves 112 supported thereon. Valve assembly 108 can also, optionally, include a suitable exhaust, such as a muffler 114, for example, for venting pressurized gas from the system. Optionally, pressurized gas system 104 can also include a reservoir 116 in fluid communication with the compressor and/or valve assembly 108 and suitable for storing pressurized gas.

Valve assembly 108 is in communication with gas spring assemblies 102 through suitable gas transfer lines 118. As such, pressurized gas can be selectively transferred into and/or out of the gas spring assemblies through valve assembly 108 by selectively operating valves 112, such as to alter or maintain vehicle height at one or more corners of the vehicle, for example.

Suspension system 100 can also include a control system 120 that is capable of communication with any one or more systems and/or components (not shown) of vehicle VHC and/or suspension system 100, such as for selective operation and/or control thereof. Control system 120 can include a controller or electronic control unit (ECU) 122 communicatively coupled with compressor 106 and/or valve assembly 108, such as through a conductor or lead 124, for example, for selective operation and control thereof, which can include supplying and exhausting pressurized gas to and/or from gas spring assemblies 102. Controller 122 can be of any suitable type, kind and/or configuration.

In accordance with the subject matter of the present disclosure, control system 120 can also include one or more height (or distance) sensing devices 126 (which are also referred to herein by terms such as displacement sensors and the like), such as, for example, may be operatively associated with the gas spring assemblies and capable of outputting or otherwise generating data, signals and/or other communications having a relation to a height of the gas spring assemblies or a distance between other components of the vehicle. Height sensing devices 126 can be in communication with ECU 122, which can receive the height or distance signals therefrom. The height sensing devices can be in communication with ECU 122 in any suitable manner, such as through conductors or leads 128, for example. In a preferred arrangement, in accordance with the subject matter of the present disclosure, height sensing devices 126 can be of a type, kind and/or construction that utilize time-of-flight measurement of photons to generate data, signals and/or other communications having a relation to a height of the gas spring assemblies or to a distance between other components of the vehicle.

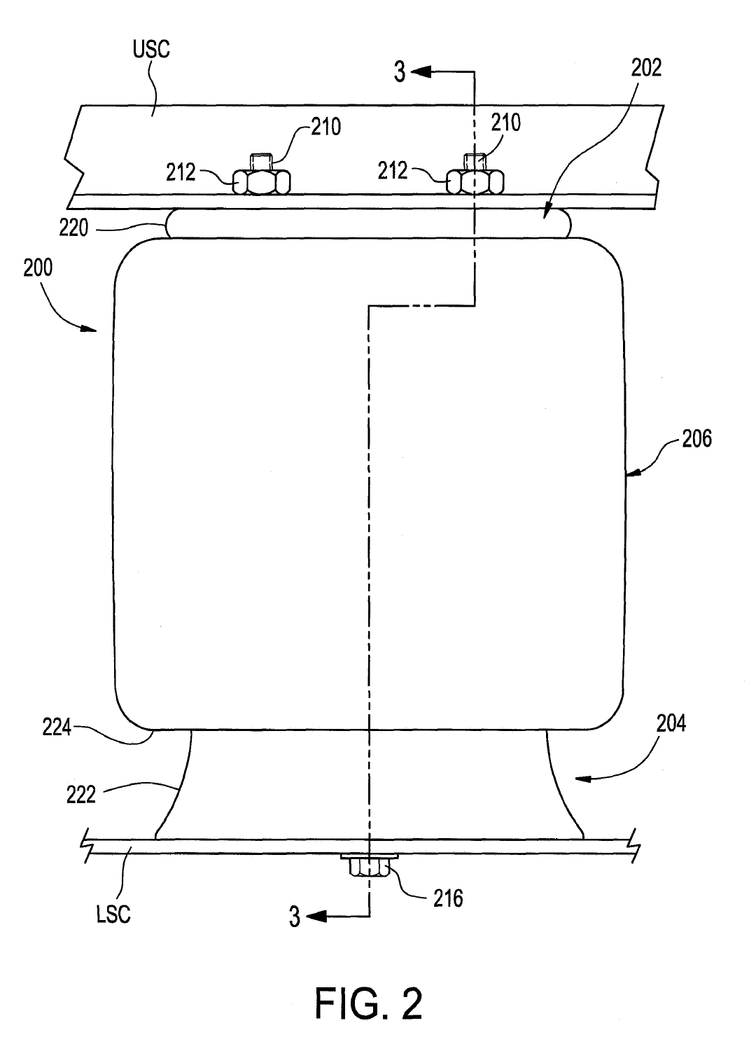

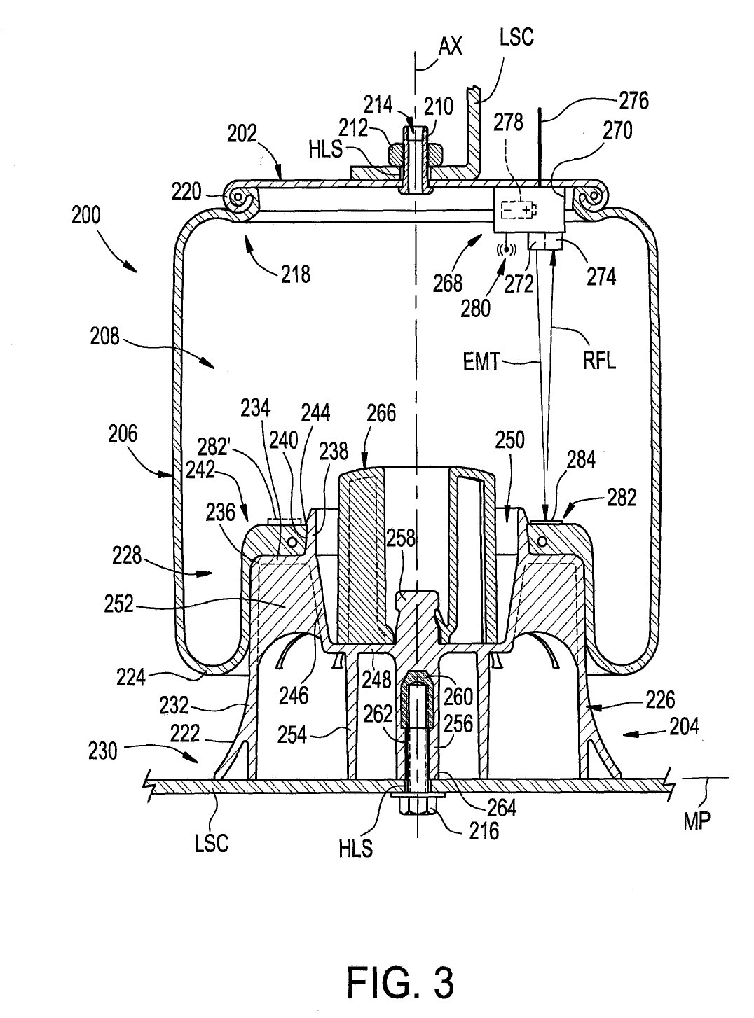

One example of a gas spring assembly 200 in accordance with the subject matter of the present disclosure is shown in FIGS. 2 and 3 as having a longitudinally-extending axis AX (FIG. 3) and can include one or more end members, such as an end member 202 and an end member 204 that is spaced longitudinally from end member 202. A flexible wall 206 can extend peripherally around axis AX and can be secured between the end members in a substantially fluid-tight manner such that a spring chamber 208 (FIG. 3) is at least partially defined therebetween.

Gas spring assembly 200 can be disposed between associated sprung and unsprung masses of an associated vehicle in any suitable manner. For example, one end member can be operatively connected to the associated sprung mass with the other end member disposed toward and operatively connected to the associated unsprung mass. In the arrangement shown in FIGS. 2 and 3, for example, end member 202 is secured along a first or upper structural component USC, such as associated vehicle body BDY in FIG. 1, for example, and can be secured thereon in any suitable manner. For example, one or more securement devices, such as mounting studs 210, for example, can be included along end member 202. In some cases, the one or more securement devices (e.g., mounting studs 210) can project outwardly from end member 202 and can be secured thereon in a suitable manner, such as, for example, by way of a flowed-material joint (not shown) or a press-fit connection (not identified). Additionally, such one or more securement devices can extend through mounting holes HLS (FIG. 3) in upper structural component USC and receive one or more threaded nuts 212 or other securement devices, for example. As an alternative to one or more of mounting studs 210, one or more threaded passages (e.g., blind passages and/or through passages) could be used in conjunction with a corresponding number of one or more threaded fasteners.

Additionally, a fluid communication port, such as a transfer passage 214 (FIG. 3), for example, can optionally be provided to permit fluid communication with spring chamber 208, such as may be used for transferring pressurized gas into and/or out of the spring chamber, for example. In the exemplary embodiment shown, transfer passage 214 extends through at least one of mounting studs 210 and is in fluid communication with spring chamber 208. It will be appreciated, however, that any other suitable fluid communication arrangement could alternately be used.

End member 204 can be secured along a second or lower structural component LSC, such as an axle AXL in FIG. 1, for example, in any suitable manner. As one example, lower structural component LSC could include one or more mounting holes HLS extending therethrough. In such case, a threaded fastener 216 could extend through one of mounting holes HLS and threadably engage end member 204 to secure the end member on or along the lower structural component.

It will be appreciated that the one or more end members can be of any suitable type, kind, construction and/or configuration, and can be operatively connected or otherwise secured to the flexible wall in any suitable manner. In the exemplary arrangement shown in FIGS. 2 and 3, for example, end member 202 is of a type commonly referred to as a bead plate and is secured to a first end 218 of flexible wall 206 using a crimped-edge connection 220. End member 204 is shown in the exemplary arrangement in FIGS. 2 and 3 as being of a type commonly referred to as a piston (or a roll-off piston) that has an outer surface 222 that abuttingly engages flexible wall 206 such that a rolling lobe 224 is formed therealong. As gas spring assembly 200 is displaced between extended and collapsed conditions, rolling lobe 224 is displaced along outer surface 222 in a conventional manner.

As identified in FIG. 3, end member 204 includes an end member body 226 and extends from along a first or upper end 228 toward a second or lower end 230 that is spaced longitudinally from end 228. Body 226 includes a longitudinally-extending outer side wall 232 that extends peripherally about axis AX and at least partially defines outer surface 222. An end wall 234 is disposed transverse to axis AX and extends radially inward from along a shoulder portion 236, which is disposed along the outer side wall toward end 228. Body 226 also includes a first inner side wall 238 that extends longitudinally outward beyond end wall 234 and peripherally about axis AX. First inner side wall 238 has an outer surface 240 that is dimensioned to receive a second end 242 of flexible wall 206 such that a substantially fluid-tight seal can be formed therebetween. A retaining ridge 244 can project radially outward from along first inner side wall 238 and can extend peripherally along at least a portion thereof.

Body 226 also includes a second inner side wall 246 that extends longitudinally inward into the body from along end wall 234. Second inner side wall 246 terminates at an end or bottom wall 248 that is approximately planar and disposed transverse to axis AX such that second inner side wall 246 and bottom wall 248 at least partially define a cavity 250 within body 226. In some cases, bridge walls 252 can, optionally, extend between and operatively interconnect outer side wall 232 and second inner side wall 246.

An inner support wall 254 is disposed radially inward from outer side wall 232 and extends peripherally about axis AX. In some cases, inner support wall 254 can form a hollow column-like structure that projects from along bottom wall 248 in a longitudinal direction toward end 230. In some cases, the distal end of outer side wall 232 and/or the distal end of inner support wall 254 can at least partially define a mounting plane MP formed along end 230 of the end member body. In this manner, body 226 can be supported at least in part by outer side wall 232 and/or inner support wall 254, such as on or along an associated structural member (e.g., lower structural component LSC in FIGS. 2 and 3). In some cases, axially applied loads or forces transmitted to bottom wall 248, such as from impacts imparted on a jounce bumper, for example, can be reacted, communicated or otherwise at least partially transferred to the associated mounting structure by the inner support wall.

Body 226 can also include a central or support post wall 256 that is disposed radially inward from inner support wall 254 and forms a post-like structure that projects from along bottom wall 248 in a direction toward end 230. In some cases, central wall 256 can terminate in approximate alignment with mounting plane MP, such as is illustrated in FIG. 3, for example.

Additionally, end member body 226 of end member 204 can include a bumper mount 258 that is disposed along bottom wall 248 and projects outwardly therefrom in an axial direction toward end 228 of the end member body. Additionally, as indicated above, end member 204 can include any number of one or more features and/or components. For example, end member 204 can include an insert 260 that is embedded (e.g., molded) into or otherwise captured and retained within end member body 226. Insert 260 can function to assist in securing the end member on or along an associated structural component, such as providing a mounting and/or securement point for the end member. As one example, insert 260 can include a hole or opening 262 that can extend into the insert body from along an end surface 264. In a preferred arrangement, the insert body can include a securement feature. In the arrangement shown, the securement feature can take the form of one or more helical threads that are cooperative with corresponding securement features (e.g., one or more helical threads formed on or along threaded fastener 216.

Gas spring assembly 200 can also, optionally, include a jounce bumper 266 that can be supported within spring chamber 208, such as to inhibit direct contact between end members 202 and 204, for example. It will be appreciated that the jounce bumper, if included, can be supported on or along an end member in any suitable manner. For example, jounce bumper 266 is shown as being received on and retained in position on or along end member 204 by bumper mount 258.

Gas spring assembly 200 is also shown in FIG. 3 as including a height or distance sensing device in accordance with the subject matter of the present disclosure. It will be appreciated that a displacement sensor in accordance with the subject matter of the present disclosure can be operatively supported within the spring chamber of the gas spring assembly in any suitable manner, and can include one or more components supported on or along either or both of end members 202 and/or 204. For example, in the arrangement shown in FIG. 3, a displacement sensor 268 is shown as being disposed within spring chamber 208 and supported along end member 202. Displacement sensor 268 includes a sensor housing 270 that is secured in a suitable manner to end member 202. In accordance with the subject matter of the present disclosure, displacement sensor 268 also includes a photon source 272 and a photon receptor 274. In a preferred arrangement, such as is shown in FIG. 3, the photon source and photon receptor can be operatively disposed along a common component (e.g., one of end members 202 and 204) and in proximal relation to one another. However, it will be appreciated that other configurations and/or arrangements could alternately be used without departing from the subject matter of the present disclosure.

Additionally, it will be appreciated that displacement sensor 268 can be connected to other systems and/or components of a vehicle suspension system in any suitable manner. For example, displacement sensor 268 could include one or more leads or conductors 276 that can be used to provide electrical power to the displacement sensor and/or for communication purposes (e.g., signals, data and/or communication transfer to and/or from the displacement sensor), such as is indicated by leads 128 of control system 120 in FIG. 1, for example. Additionally, or in the alternative, displacement sensor 268 can include a self-contained power source 278 (e.g., batteries) and/or an antenna 280 suitable for wireless reception and/or transmission of signals, data and/or information for communication and/or other purposes.

During use, in accordance with the subject matter of the present disclosure, displacement sensor 268 is shown in FIG. 3 as being operable to emit photons from photon source 272 in a direction toward a target feature or component for which a height or distance is to be determined, as is represented by arrow EMT. The emitted photons are reflected off of the target feature or component in a direction back toward photon receptor 274, as is represented by arrow RFL. In many cases, a displacement sensor in accordance with the subject matter of the present disclosure will operate properly while reflecting photons off of a surface of the target feature or component itself. In some cases, however, it may be desirable to separately provide a reflective target having a target surface with predetermined reflective properties, such as may be useful to provide a particular level of performance or robustness of operation.

For example, though optional, gas spring assembly 200 and/or displacement sensor 268 can include a reflective target 282 having a target surface 284 off of which photons can be reflected from photon source 272 toward photon receptor 274, such as is shown in FIG. 3, for example. It will be appreciated that reflective target 282 and target surface 284 thereof can be of any suitable size, shape and/or configuration. For example, reflective target 282 is shown in FIG. 3 as being a spot target disposed in a desired position along end member 204 relative to displacement sensor 268. In the alternative, a reflective target 282′ could be used that extends peripherally about axis AX such that an annular target surface is provided that will align with displacement sensor 268 regardless of the rotational orientation of the displacement sensor and the reflective target relative to one another about axis AX. Again, depending upon the anticipated conditions of use in a particular application and the desired performance characteristics and/or robustness of operation, the target surface (whether a surface of the target feature or component or a dedicated reflective surface, such as reflective surface 284) can have a diffuse reflectance, a specular reflectance or a retroreflectance. As will be discussed in greater detail hereinafter, displacement sensor 268, or a system or component operatively associated with the displacement sensor, can be operable to determine time of flight of photons traveling at the speed of light (i.e., 299,700,000 meters per second in air) from the photon source, to the reflective surface and then to the photon receptor. It will be appreciated that the roundtrip distance traveled by the photons will have a relation to the time of flight. Thus, by determining the time of flight of the photons, displacement sensor 268, or a system or component operatively associated with the displacement sensor, can then determine a height or distance associated with the gas spring assembly or other components of a suspension system.

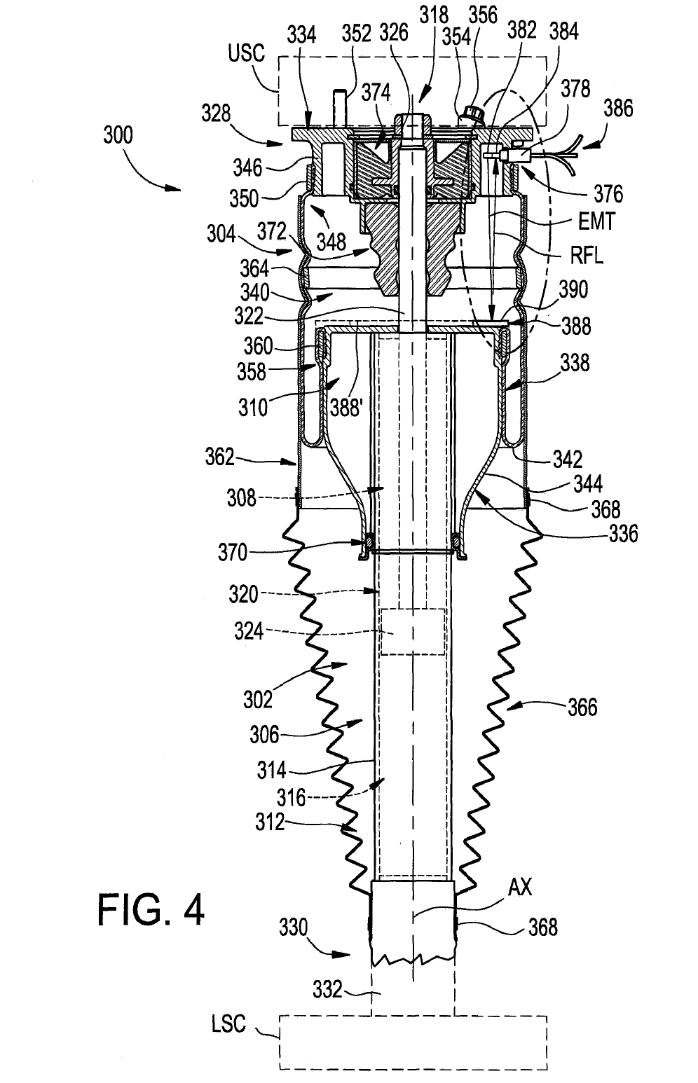

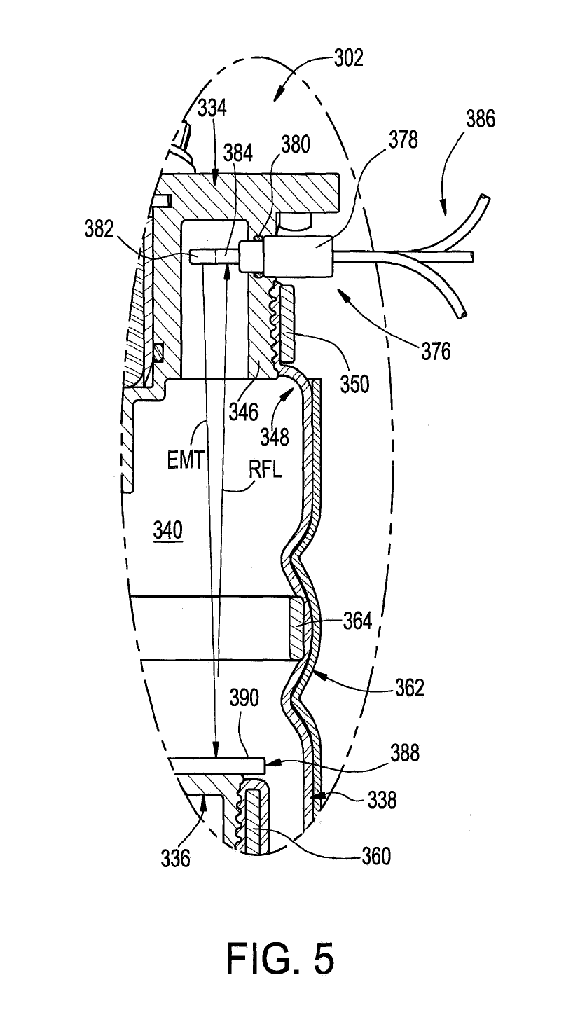

Another example of a gas spring assembly in accordance with the subject matter of the present disclosure can take the form of a gas spring and damper assembly 300, as is shown in FIGS. 4 and 5. Gas spring and damper assembly 300 can include a damper assembly 302 and a gas spring assembly 304 that is operatively connected with the damper assembly. It will be appreciated that, in some cases, gas spring and damper assembly 300 can, for example, be installed on an associated vehicle to at least partially form an associated suspension thereof. In such cases, gas spring and damper assembly 300 can undergo changes in length (i.e., can be displaced between extended and collapsed conditions) and thereby allow the components of the vehicle and the suspension system thereof to dynamically move to accommodate forces and/or inputs acting on the vehicle, such as has been described above and is well understood by those of skill in the art.

Gas spring and damper assembly 300 is shown in FIGS. 4 and 5 as having a longitudinally-extending axis AX with damper assembly 302 and gas spring assembly 304 operatively secured to one another around and along axis AX. Damper assembly 302 is shown in FIGS. 4 and 5 as extending along axis AX and including a damper housing 306 and a damper rod assembly 308 that is at least partially received in the damper housing. Damper housing 306 can extend axially between opposing housing ends 310 and 312, and can include a housing wall 314 that at least partially defines a damping chamber 316. Damper rod assembly 308 can extend lengthwise between opposing ends 318 and 320 and can include an elongated damper rod 322 and a damper piston 324 disposed along end 320 of damper rod assembly 308. Damper piston 324 is received within damping chamber 316 of damper housing 306 for reciprocal movement along the housing wall in a conventional manner. A quantity of damping fluid (not shown) can be disposed within damping chamber and damper piston 324 can be displaced through the damping fluid to dissipate kinetic energy acting on gas spring and damper assembly 300, again, in a conventional manner. Though damper assembly 302 is shown and described herein as having a conventional construction in which a hydraulic fluid is contained within at least a portion of damping chamber 316, it will be recognized and appreciated that dampers of other types, kinds and/or constructions, such as pressurized gas or “air” dampers, for example, could be used without departing from the subject matter of the present disclosure.

Elongated rod 322 is shown in FIGS. 4 and 5 projecting out of damper housing 306 such that the elongated rod is outwardly exposed from the damper housing and is externally accessible with respect to the damper housing. A connection feature 326, such as a plurality of threads, for example, can be provided on or along the elongated rod for use in operatively connecting gas spring and damper assembly 300 to an associated vehicle structure, a component of gas spring assembly 304 or another component of gas spring and damper assembly 300.

It will be appreciated that gas spring and damper assembly 300 can be operatively connected between associated sprung and unsprung masses of an associated vehicle (or other construction) in any suitable manner. For example, one end of the assembly can be operatively connected to the associated sprung mass with the other end of the assembly disposed toward and operatively connected to the associated unsprung mass. As shown in FIGS. 4 and 5, for example, a first or upper end 328 of assembly 300 can be secured on or along a first or upper structural component USC, such as an associated vehicle body, for example, and can be secured thereon in any suitable manner. A second or lower end 330 of assembly 300 can be secured on or along a second or lower structural component LSC, such as an associated axle or suspension structure of a vehicle, for example, and can be secured thereon in any suitable manner. In some cases, damper assembly 302 can include a connection feature 332, such as a pivot or bearing mount (not shown), for example, that is operatively disposed along damper housing 306 and is adapted for securement to lower structural component LSC in a suitable manner.

Gas spring assembly 304 includes an end member 334, such as a top cap, bead plate or reservoir enclosure, for example. Gas spring assembly 304 also includes an end member 336, such as a roll-off piston or piston assembly, for example, that is disposed in axially-spaced relation to end member 334. A flexible spring member 338, in accordance with the subject matter of the present disclosure, can be operatively connected between end members 334 and 336 in a substantially fluid-tight manner such that a spring chamber 340 is at least partially defined therebetween. In some cases, flexible spring member 338 can form a rolling lobe 342 that is displaced along an outer surface 344 of end member 336 as gas spring and damper assembly 300 moves between extended (i.e., rebound) and compressed (i.e., jounce) conditions. As shown in FIGS. 4 and 5, end member 336 can include a wall portion 346 along which one end 348 of flexible spring member 338 is operatively connected, such as, for example, through the use of a retaining ring 350 that can be crimped radially inward or otherwise deformed to form a substantially fluid-tight connection therebetween.

As discussed above, gas spring and damper assembly 300 can be operatively connected between associated sprung and unsprung masses of an associated vehicle (or other structure) in any suitable manner. As shown in FIGS. 4 and 5, for example, end 328 of assembly 300 can be secured on or along upper structural component USC in any suitable manner. As one example, one or more securement devices, such as mounting studs 352, for example, can be included along end member 334. In some cases, the one or more securement devices (e.g., mounting studs 352) can project outwardly from end member 334 and can be secured thereon in a suitable manner, such as, for example, by way of a flowed-material joint (not shown) or a press-fit connection (not identified). Additionally, such one or more securement devices can extend through mounting holes (not shown) in upper structural component USC and can receive one or more threaded nuts (not shown) or other securement devices, for example. Additionally, or as an alternative to one or more of mounting studs 352, one or more threaded passages (e.g., blind passages and/or through passages) could be used in conjunction with a corresponding number of one or more threaded fasteners.

A fluid communication port can optionally be provided to permit fluid communication with spring chamber 340, such as may be used for transferring pressurized gas into and/or out of the spring chamber, for example. It will be appreciated that such a fluid communication port can be provided in any suitable manner. As one example, a fluid communication port could extend through one or more of mounting studs 352. As another example, end member 334 can include a transfer passage 354 extending therethrough that is in fluid communication with spring chamber 340. It will be appreciated, however, that any other suitable fluid communication arrangement could alternately be used. In some cases, passage 354 can be adapted to receive a suitable connector fitting 356, such as may be suitable for operatively connecting gas transfer lines 118 in FIG. 1, for example, or other elements of a pressurized gas system to the gas spring and damper assembly.

An opposing end 358 of flexible sleeve 338 can be secured on or along end member 334 in any suitable manner. As one example, a portion of the flexible sleeve can be secured in abutting engagement along a wall portion of end member 334 by way of a retaining ring 360 that can be crimped radially inward or otherwise deformed to form a substantially fluid-tight connection therebetween. Additionally, gas spring and damper assembly 300 can, optionally, include an external sleeve or support, such as a restraining cylinder 362, for example, that can be secured on or along the flexible sleeve in any suitable manner. As one example, a portion of the flexible sleeve can be secured in abutting engagement along a wall portion of restraining cylinder 362 by way of a retaining ring 364 that can be crimped radially outward or otherwise deformed to form engagement between the restraining cylinder and the flexible sleeve. It will be appreciated, however, that other arrangements could alternately be used.

Gas spring and damper assembly 300 can also, optionally, include one or more additional components and/or features. For example, an accordion-type bellows 366 can extend along at least a portion of the gas spring and damper assembly and can be secured to one or more components thereof in any suitable manner, such as by way of retaining rings 368, for example. As another example, a seal assembly 370 can be disposed in fluid communication between damper housing 306 and end member 336, such that a substantially fluid-tight seal can be formed therebetween. As a further example, a jounce bumper 372 can be disposed within spring chamber 340 and can be supported on or along one of end members 334 and 336 in a suitable manner. In the arrangement shown in FIGS. 4 and 5, jounce bumper 372 is received along elongated rod 322 and supported on end member 334. It will be appreciated, however, that other configurations and/or arrangements could alternately be used. Gas spring and damper assembly 300 can also include a damper rod bushing 374 that is operatively connected between elongated rod 322 of damper assembly 302 and end member 334 of gas spring assembly 304. In this manner, forces acting on one of damper rod 322 and end member 334 that are experienced during use of the gas spring and damper assembly are transmitted or otherwise communicated through damper rod bushing 374 to the other of damper rod 322 and end member 334.

Gas spring assembly 304 of gas spring and damper assembly 300 is also shown in FIGS. 4 and 5 as including a height or distance sensing device in accordance with the subject matter of the present disclosure. It will be appreciated that a displacement sensor in accordance with the subject matter of the present disclosure can be operatively supported within the spring chamber of the gas spring assembly in any suitable manner, and can include one or more components supported on or along either or both of end members 334 and/or 336. For example, in the arrangement shown in FIGS. 4 and 5, a displacement sensor 376 is shown as being disposed within spring chamber 340 and supported along end member 334. Displacement sensor 376 includes a sensor body or housing 378 that is secured in a suitable manner on or along end member 334. In a preferred arrangement, end member 334 (or, alternately, end member 336) can include a passage (not numbered) extending therethrough that is oriented transverse to axis AX. The passage can be dimensioned to cooperatively engage sensor body 378 such that displacement sensor 376 can be operatively secured on or along the end member. In some cases, one or more sealing elements 380 can be disposed between sensor body 378 and the end member wall portion such that a substantially fluid-tight seal can be formed and maintained therebetween. In accordance with the subject matter of the present disclosure, displacement sensor 376 also includes a photon source 382 and a photon receptor 384. In a preferred arrangement, such as is shown in FIGS. 4 and 5, for example, the photon source and photon receptor can be operatively disposed along a common component (e.g., one of end members 334 and 336) and in proximal relation to one another. However, it will be appreciated that other configurations and/or arrangements could alternately be used without departing from the subject matter of the present disclosure.

Additionally, it will be appreciated that displacement sensor 376 can be communicatively coupled or otherwise connected to other systems and/or components of a vehicle suspension system in any suitable manner. For example, displacement sensor 376 could include one or more leads or conductors 386 that can be used to provide electrical power to the displacement sensor and/or for communication purposes (e.g., signals, data and/or communication transfer to and/or from the displacement sensor), such as is indicated by leads 128 of control system 120 in FIG. 1, for example. Additionally, or in the alternative, the displacement sensor can include a self-contained power source (e.g., batteries) and/or an antenna suitable for wireless reception and/or transmission of signals, data and/or information for communication and/or other purposes, such as has been described above in connection with power source 278 and/or antenna 280, for example.

During use, in accordance with the subject matter of the present disclosure, displacement sensor 376 is shown in FIGS. 4 and 5 as being operable to emit photons from photon source 382 in a direction toward a target feature or component for which a height or distance is to be determined, as is represented by arrow EMT. The emitted photons are reflected off of the target feature or component in a direction back toward photon receptor 384, as is represented by arrow RFL. In many cases, a displacement sensor in accordance with the subject matter of the present disclosure will operate properly while reflecting photons off of a surface of the target feature or component itself. In some cases, however, it may be desirable to separately provide a reflective target having a target surface with predetermined reflective properties, such as may be useful to provide a particular level of performance or robustness of operation. For example, though optional, gas spring assembly 304 and/or displacement sensor 376 can include a reflective target 388 having a target surface 390 off of which photons can be reflected from photon source 382 toward photon receptor 384, such as is shown in FIGS. 4 and 5, for example. It will be appreciated that reflective target 388 and target surface 390 thereof can be of any suitable size, shape and/or configuration. For example, reflective target 388 is shown in FIGS. 4 and 5 as being a spot target disposed in a desired position along end member 336 relative to displacement sensor 376. In the alternative, a reflective target 388′ could be used that extends peripherally about axis AX such that an annular target surface is provided that will align with displacement sensor 376 regardless of the rotational orientation of the displacement sensor and the reflective target relative to one another about axis AX.

Again, depending upon the anticipated conditions of use in a particular application and the desired performance characteristics and/or robustness of operation, the target surface (whether a surface of the target feature or component or a dedicated reflective surface, such as reflective surface 390) can have a diffuse reflectance, a specular reflectance or a retroreflectance. As will be discussed in greater detail hereinafter, displacement sensor 376, or a system or component operatively associated with the displacement sensor, can be operable to determine time of flight of photons traveling at the speed of light (i.e., 299,700,000 meters per second in air) from the photon source, to the reflective surface and then to the photon receptor. It will be appreciated that the roundtrip distance traveled by the photons will have a relation to the time of flight. Thus, by determining the time of flight of the photons, displacement sensor 376, or a system or component operatively associated with the displacement sensor, can then determine a height or distance associated with the gas spring assembly or other components of a suspension system.

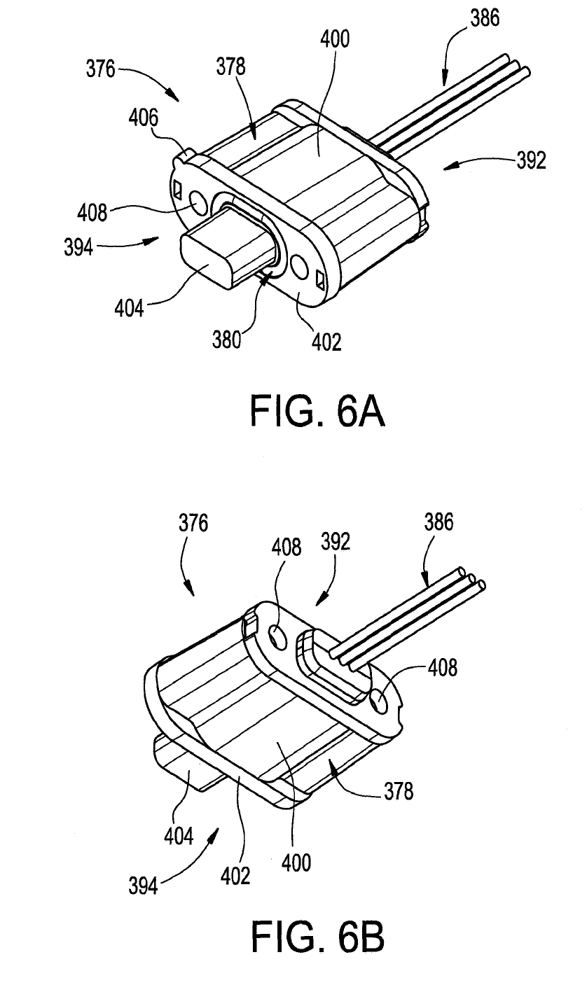

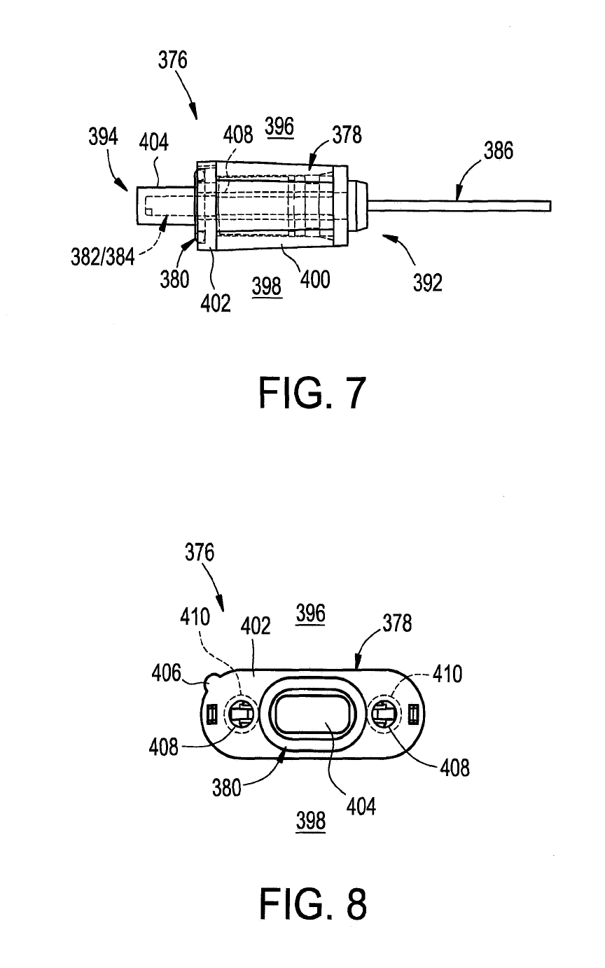

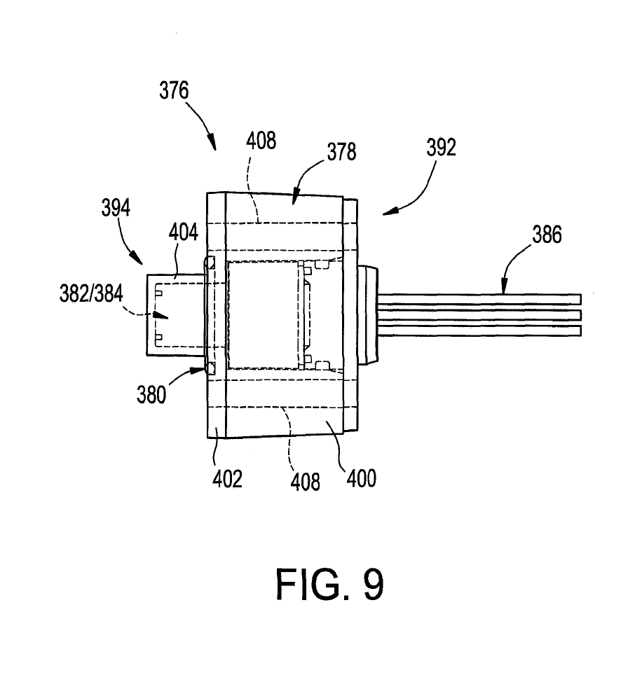

FIGS. 6A, 6B and 7-9 illustrate displacement sensor 376 and sensor body 378 in greater detail. It will be appreciated that sensor body 378 can include any suitable number of one or more walls and/or wall portions. For example, sensor body 378 extends lengthwise from an end 392 to an end 394 and has a top 396 and a bottom 398. Sensor body 378 is shown as including a body wall portion 400 disposed toward end 392 and a mounting wall portion 402 disposed along body wall portion 400 toward end 394. Sensor body 378 also includes a sensing wall portion 404 that projects outwardly from along mounting wall portion 394 in a direction opposite body wall portion 400.

In the configuration shown in FIGS. 2 and 3 as well as in FIGS. 4, 5, 6A, 6B and 7-9, the displacement sensor is oriented such that the photon source emits photons in the direction of a predetermined target surface. As such, it will be appreciated that sensor 126, 268 and/or 376 can, in some cases, include one or more features operable to orient or otherwise ensure that the sensor is installed in the desired orientation. As one example, sensor body 378 can include one or more indexing features 406 disposed on or along mounting wall portion 402. In a preferred arrangement, indexing feature 406 is dimensioned to cooperatively engage a corresponding indexing feature on or along the associated end member. In the arrangement shown in FIGS. 6A, 6B and 7-9, indexing feature 406 is in the form of a projection extending outwardly from along mounting wall portion 402. In such case, the corresponding securement feature of the associated end member could take the form of a groove or slot dimensioned to at least partially receive indexing feature 406. It will be appreciated, however, that other configurations and/or arrangements could alternately be used.

Additionally, it will be appreciated that displacement sensor 376 can be secured on or along the associated end member (e.g., one of end members 334 and 336) in any suitable manner. As one example, sensor body 378 can include one or more mounting holes 408, such as may be suitable for receiving securement devices (not shown) dimensioned to cooperatively engage the associated end member to attach or otherwise secure the displacement sensor thereon. In a preferred arrangement, sensor body 378 can include one or more compression limiting features, such as compression limiting cylinders 410, for example, that are operative to substantially inhibit inadvertent deflection and/or deformation of sensor body 378 and/or other components of displacement sensor 376, such as might otherwise occur during installation, for example.

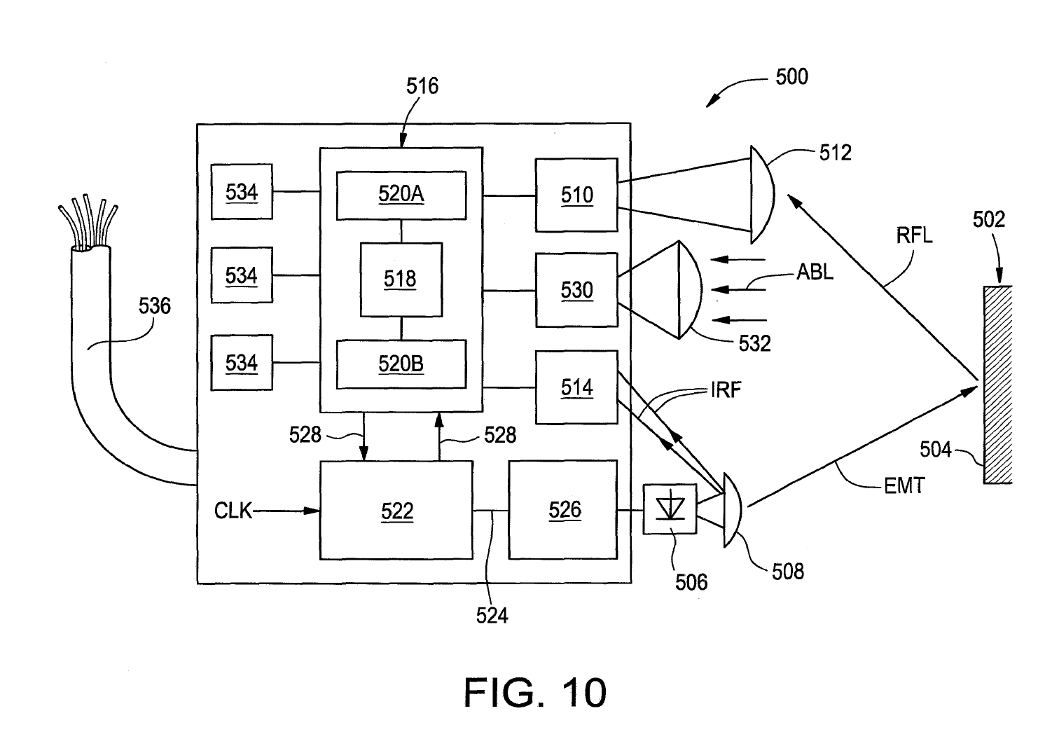

FIG. 10 schematically illustrates one example of a displacement sensor 500 in accordance with the subject matter of the present disclosure, such as may be suitable for use as one or more of sensors 126, 268 and 376, for example. As discussed above, sensor 500 is preferably of a type, kind and/or construction that utilize time-of-flight measurement of photons to generate data, signals and/or other communications having a relation to a height of the gas spring assemblies or to a distance between other components of an associated vehicle or other structure. In FIG. 10, a predetermined target 502 having a target surface 504 is disposed in spaced relation to displacement sensor 500 such that a distance therebetween can be determined by the displacement sensor in accordance with the subject matter of the present disclosure.

Sensor 500 includes a photon source 506 that is operable to emit photons through a lens 508 toward target surface 504, as is represented in FIG. 10 by arrow EMT. Displacement sensor 500 also includes a photon receptor 510 that is operable sense or otherwise detect the presence of photons received through lens 512. Displacement sensor 500 can also include a reference photon detector 514 that is operable to sense or otherwise detect the presence of photons received by way of a reflection of emitted photons that is internal to the displacement sensor, as is represented in FIG. 10 by arrows IRF. The displacement sensor also includes a delay detector 516 that is operable to determine a time difference between the emission of photons from photon source 506 and the detection of emitted photons at photon receptor 510. Due to the travel of photons at the speed of light (through air at 299,700,000 meters per second), the time taken to travel from the photon source, to the target reflector and return to the photon detector is extremely small. However, such a time difference is measurable.

Delay detector 516 can be constructed or otherwise provided in any suitable manner. As one example, a delay detection circuit could be used, such as is described in detail in U.S. Patent Publication No. 2016/0291316, which was published on Oct. 6, 2016 in the names of STMicroelectronics Limited of Marlow Bucks, Great Britain and STMicroelectronics SAS of Grenoble, France, and entitled OPTICAL SIGNAL GENERATION IN A SPAD ARRAY. Alternately, the delay detector could include a combination of hardware, firmware and/or software operable to determine a time difference between the emission of photons from photon source 506 and the detection of emitted photons at photon receptor 510. For example, displacement sensor 500 is shown in FIG. 10 as including a controller or processing device 518, which can be of any suitable type, kind and/or configuration, such as a microprocessor, for example, for processing data, executing software routines/programs, and other functions relating to at least the determination of a time difference between the emission of photons from photon source 506 and the detection of emitted photons at photon receptor 510.

Additionally, displacement sensor 500 can include a non-transitory storage device or memory, which can be of any suitable type, kind and/or configuration that can be used to store data, values, settings, parameters, inputs, software, algorithms, routines, programs and/or other information or content for any associated use or function, such as use in association with the determination of a time difference between the emission of photons from photon source 506 and the detection of emitted photons at photon receptor 510 and/or with the performance and/or operation of the displacement sensor 500 as well as any systems, components and/or features of the gas spring assemblies and/or suspension system with which the displacement sensor may be operatively associated.

As such, displacement sensor 500 can include a non-transitory storage device or memory, which is represented in FIG. 10 by boxes 520A and 520B, that is suitable for data, values, settings, parameters, inputs, software, algorithms, routines, programs and/or other information or content for any associated use or function. Non-transitory memory stores 520A and 520B are communicatively coupled with processing device 518 such that the processing device can access the memory stores to retrieve and execute any one or more software programs and/or routines. Additionally, data, values, settings, parameters, inputs, software, algorithms, routines, programs and/or other information or content can also be retained within memory 520A and 520B for retrieval by processing device 518. It will be appreciated that such software routines can be individually executable routines or portions of a software program, such as an operating system, for example. Additionally, it will be appreciated that the control system, including any controller, processing device and/or memory, can take any suitable form, configuration and/or arrangement, and that the embodiments shown and described herein are merely exemplary. Furthermore, it is to be understood, however, that the modules described above in detail can be implemented in any suitable manner, including, without limitation, software implementations, hardware implementations or any combination thereof.

Displacement sensor 500 can also include any other components, circuits, data, values, settings, parameters, inputs, software, algorithms, routines, programs and/or other information or content for operation and use of the displacement sensor. For example, displacement sensor 500 can include a frequency generator 522 that can be implemented as any combination of circuitry and software. A clock signal CLK can be provided to frequency generator 522, which can generate a voltage signal 524 that is provided to a driver 526 for generating a signal for driving photon source 506. Delay detector 516 can also be operative to generate and communicate phase control signals 528 to frequency generator 522, such as is described in detail in U.S. Patent Publication No. 2016/0291316 discussed above.

Displacement sensor 500 can further include an ambient light sensor 530 that is operable to detect a level of ambient light in a surrounding environment through lens 532, such as is represented by arrows ABL in FIG. 10, for example. Processing device 518 and memory stores 520A and 520B are preferably configured to detect and measure ambient light conditions through operation of ambient light sensor 530. In some cases, displacement sensor 500 can also include one or more additional sensors and/or other components, such as are represented by boxes 534 in FIG. 10, which are communicatively coupled to processing device 518 and memory stores 520A and 520B. As non-limiting examples, boxes 534 can represent temperature sensors, pressure sensors, accelerometers and/or inertial measurement units. In some cases, displacement sensor 500 can be contained in a sensor body or housing 536, such as has been discussed above in detail for example in connection with other embodiments. Additionally, displacement sensor 500 can be communicatively coupled with other systems and/or components (e.g., controller 122 in FIG. 1) in any suitable manner. For example, the displacement sensor can include one or more leads or conductors 538 that are communicatively coupled with one or more components of the displacement sensor.

Using such an arrangement, displacement sensor 500 can function as an extremely accurate ride height sensor that is capable of providing signals, data and/or other information regarding an average relative distance between gas spring end members and/or other components of a vehicle or other structure. Advantageously, displacement sensor 500 can accomplish these and other functions from the enclosed environment of the interior of a gas spring assembly (e.g., gas spring assemblies 102, 200 and 304), thereby isolating the displacement sensor and any reflector target, if provided, from the deleterious effects of environments to which vehicle suspension systems are commonly exposed.

It will be appreciated that photon source 506 can take the form of any suitable type and/or kind of device. As one example, photon source 506 can include a laser diode. In a preferred arrangement, the laser diode can take the form of a vertical-cavity surface-emitting laser (VCSEL). It will be appreciated that photon source 506 can emit photons having any suitable wavelength, such as a wavelength in a range of from approximately six hundred fifty (650) nanometers to approximately two thousand (2000) nanometers, for example. Additionally, it will be appreciated that photon receptor 510 and reference photon detector 514 can be of any suitable type, kind and/or construction. In a preferred construction, photon receptor 510 and reference photon detector 514 can include single-photon avalanche diode (SPAD) arrays, such as are described in U.S. Patent Publication No. 2016/0291316 discussed above.

As discussed above, the subject matter of the present disclosure can include an integrated circuit that measures instantaneous, absolute displacement based measurements using the time of flight of emitted photons. Such a construction will allow absolute distance measurement independent of target reflectance by precisely measuring the time the light takes to travel to the target reflector. Displacement sensors in accordance with the subject matter of the present disclosure can operate within a range of from approximately zero (0) centimeters to approximately twenty (20) centimeters, with one hundred (100) centimeter ranging being possible using specific reflected target material.

It has been determined that ambient light conditions within a gas spring assembly can be as low as 0.5 lumens. As such, a displacement sensor in accordance with the subject matter of the present disclosure is preferably designed to function properly under ambient light conditions within a range of from approximately zero (0) lumens to full sunlight. Additionally, as it concerns target reflectors and the reflectance of target surfaces, it will be appreciated that any one of various reflector surfaces can be used. In some cases, a natural or untreated surface of an existing component having a reflectance of as low as three (3) percent could be used. In other cases, reflector surfaces can be utilized that provide improved accuracy and/or robustness of operation, such as accuracy resolution for the displacement of less than one (1) millimeter can be used. Such an internal height sensor can be powered by a 5V voltage regulated and coupled source, with an adjustable digital output rate, such as a 16-bit digital output rate, for example, of the signal with an adjustable sample rate, such as ten (10) averaged samples. An intended operation range of this internal height sensor can be within a temperature range of approximately −40° C. to approximately 85° C.

In some cases, details and/or specifications such as those described below can correspond to additional operating parameters and/or performance characteristics of a displacement sensor in accordance with the subject matter presented in this application. For example, in some cases an absolute accuracy within a range of +/−4 millimeters can be used with a range of +/−1 millimeter being achieved under certain conditions of use. As another example, in some cases a relative accuracy within a range of +/−2 millimeter can be used. As a further example, in some cases a sampling period of approximately 10 milliseconds can be used in which case the displacement sensor can report a new height or distance measurement every 10 milliseconds.

In order to meet the difficult environmental requirements associated with certain applications and/or conditions of use, a displacement sensor assembly in accordance with the subject matter of the present disclosure can include one or more of an injection molded housing and an over-molded housing of the sensor's circuitry. In the case of injection molded housings, a single-piece clear polymeric (e.g., polycarbonate) part can be used where the printed circuit board was populated, then inserted into the housing. A potting compound can be shot into the housing to seal the unit. The housing can have a gasket on the end nearest to the optics sensor that prevents the potting compound from entering that part of the housing and to aid against corrupting the optics and thereby creating an air cavity around the optics.

With regard to the over-molded housings, a new process was developed since a standard over-molding process would likely damage the sensitive electronic and optical parts via the application of high pressure and high temperature. To overcome this challenge, a low pressure over-molding solution that also used temperatures low enough to prevent damage to the PCB and other components. These parts have shown excellent precision unit to unit since any variances in the over-molded material (e.g., acrylic) can be controlled.

As an alternative, a combination of the two foregoing methods of forming a displacement sensor body or housing could be used. In such a method of manufacture, an injection molded polycarbonate housing could be formed. Such an injection molded polycarbonate housing will form a hard enclosure that will withstand environmental conditions and satisfy performance requirements for robustly protecting any sensitive internal components of the displacement sensor. Examples of such environmental conditions and performance requirements that an injection molded polycarbonate housing can provide include pressure, temperature, impact, vibration, chemical resistance and infrared transparency. As discussed above, the displacement sensor body can include one or more sealing elements to form a substantially fluid-tight seal with the end member of the gas spring assembly.

A printed circuit board assembly (PCBA) with wires attached can then be over-molded and inserted in to the injection molded polycarbonate housing and sealed with an end cap. The over-molded material can serve as a strain relief for the wires. The over-molded material can also seal the wires to the polycarbonate housing, and fill the interior of the housing with over-molded material to reduce the internal air volume of the assembled displacement sensor. This advantageously reduces amount of moisture that can be present inside the displacement sensor to potentially condense therein. Two or more of the components can be mechanically secured together using molded-in interlocking features.

This development of a process of the packaging a time of flight internal height sensor in accordance with the subject matter of the present disclosure is beneficial since various characteristics and/or features of the packaging material, such as the optical clarity, the distance between the time of flight sensor and the material used, for example, can have a direct effect on the successful operation of the sensor.

In some cases, temperature compensation can be included that will permit an output of a time of flight sensor (e.g., displacement sensor 500) to be variable over different temperature ranges. In some cases, such adjustments can include compensating any data from the sensor via a compensation algorithm. This algorithm may be derived from taking distance/displacement data from multiple distances on multiple sensors over the entire operation temperature range (−40° C. to 85° C.). The temperature compensation algorithm, as part of the operational software for this internal height sensor as utilized can, in some cases, contribute to the successful operation of the present invention. In some cases, such a temperature compensation algorithm can be stored in memory stores 520A and 520B and executed by processing device 518.

It is a possibility that as the displacement range increases, the linearity of the sensor is affected in that non-linearity is evident as different ranges. For that reason, it may be desirable to include a range compensation algorithm to ensure that the displacement readings are linear throughout the range. For example, it may be found that the internal height sensors are sensing a displacement of 300 millimeters while the actual displacement is 310 millimeters. Under such conditions of use, a compensation algorithm could be used that is capable of automatically correcting this difference across the entire range of detection. In some cases, such a linearity compensation algorithm can be stored in memory stores 520A and 520B and executed by processing device 518.

As described above in detail, the subject matter of the present disclosure can utilize a proximity and ambient light sensing module that is capable of performing time of flight based displacement measurements of emitted photons. Such sensing modules can include one or more devices that can utilize an infrared transmitter, a range sensor, and an ambient light sensor in one package. One example of such a construction is available from STMicroelectronics of Geneva, Switzerland under the component designation VL6180X and commercially referred to as a FLIGHTSENSE™ module. It will be appreciated, however, that other devices could alternately be used.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A gas spring assembly having a longitudinal axis, said gas spring assembly comprising:
a flexible spring member including a flexible wall extending peripherally about said longitudinal axis and axially between opposing first and second ends of said flexible spring member to at least partially define a spring chamber therebetween;
a first end member secured along said first end of said flexible spring member such that a substantially fluid-tight seal is formed therebetween;
a second end member disposed in axially-spaced relation to said first end member, said second end member secured along said second end of said flexible spring member such that a substantially fluid-tight seal is formed therebetween;
a photon source operatively disposed along one of said first end member and said second end member;
a target surface operatively disposed along one of said first end member and said second end member;
a photon receptor operatively disposed along the other of said first end member and said second end member relative to said target surface; and,
a processor communicatively coupled with said photon source and said photon receptor;
said photon source operable to direct photons toward said target surface through at least a portion of said spring chamber, said photon receptor operable to generate a signal upon receiving photons reflected off said target surface from said photon source, and said processor operable to determine a distance having a relationship a time of flight of photons reflected off of said target surface from said photon source and received at said photon receptor.

2. A gas spring assembly according to claim 1, wherein said photon source includes a laser diode.

3. A gas spring assembly according to claim 2, wherein said laser diode is in the form of a vertical-cavity surface-emitting laser.

4. A gas spring assembly according to claim 1, wherein said photon source emits photons having a wavelength within a range of from approximately 650 nm to approximately 2000 nm.

5. A gas spring assembly according to claim 1, wherein said photon receptor includes a single-photon avalanche diode (SPAD) array.

6. A gas spring assembly according to claim 1, wherein said target surface has a reflectance as low as approximately three (3) percent.

7. A gas spring assembly according to claim 1, wherein said target surface is at least partially formed by a material having a reflectance of at least thirty (30) percent.

8. A gas spring assembly according to claim 1, wherein said target surface is at least partially formed by a material having one of diffuse reflectance, specular reflectance and retroreflectance.

9. A gas spring assembly according to claim 1 further comprising a sensor assembly supported on one of said first end member and said second end member, said sensor assembly including said photon source and said photon receptor.

10. A gas spring assembly according to claim 9, wherein said sensor assembly includes an ambient light sensor communicatively coupled with at least one of said photon source and said photon receptor.

11. A gas spring assembly according to claim 1, wherein said target surface is oriented transverse to said longitudinal axis and supported along said first end member, and said photon source and said photon receptor are supported along said second end member such that photons are emitted and reflected in an approximately longitudinal direction.

12. A gas spring assembly according to claim 11, wherein said second end member includes an end member wall with a passage extending therethrough that is oriented transverse to said longitudinal axis, and said sensor assembly extends into fluid communication with said spring chamber through said passage.

13. A gas spring assembly according to claim 12 further comprising a sealing element fluidically disposed between said end member wall and said sensor assembly such that a substantially fluid-tight seal is formed therebetween.

14. (canceled)

15. A displacement sensor comprising:
a photon source and a target surface disposed in spaced relation to said photon source;
a photon receptor disposed along an associated gas spring end member in spaced relation to said target surface; and,
a processor communicatively coupled with said photon source and said photon receptor;
said photon source operable to direct photons toward said target surface, said photon receptor operable to generate a signal upon receiving photons reflected off said target surface from said photon source, and said processor operable to determine a distance having a relationship to a time of flight of photons reflected off of said target surface from said photon source and received at said photon receptor.

16. A displacement sensor according to claim 15, wherein said photon source includes a laser diode.

17. A displacement sensor according to claim 16, wherein said laser diode is in the form of a vertical-cavity surface-emitting laser.

18. A displacement sensor according to claim 15, wherein said photon source emits photons having a wavelength within a range of from approximately 650 nm to approximately 2000 nm.

19. A displacement sensor according to claim 15, wherein said photon receptor includes a single-photon avalanche diode (SPAD) array.

20. A displacement sensor according to claim 15 further comprising an ambient light sensor communicatively coupled with at least one of said photon source and said photon receptor.

21. A displacement sensor according to claim 15 further comprising a sensor body containing at least a portion of at least one of said photon source and said photon receptor.
